(19) United States
(12) Patent Application Publication
(10) Pub. No.: US 2016/0245913 A1
(43) Pub. Date: Aug. 25, 2016

(54) APPARATUS AND METHOD FOR MEASURING PRECIPITATION IN THE ATMOSPHERE USING K-BAND FREQUENCY-MODULATED CONTINUOUS WAVE (FMCW) WEATHER RADAR SYSTEM

(71) Applicant: Korea Advanced Institute of Science and Technology, Yuseong-gu (KR)

(72) Inventors: Seong Ook PARK, Yuseong-gu (KR); Dong-Hun SHIN, Yuseong-gu (KR); Rao Shahid AZIZ, Yuseong-gu (KR); Yun-Seok NOH, Yuseong-gu (KR)

(21) Appl. No.: 14/626,076

(22) Filed: Feb. 19, 2015

(51) Int. Cl. G01S 13/95; G01S 7/35; G01S 13/02

(52) U.S. Cl. CPC G01S 13/95; G01S 13/0209; G01S 7/352; G01S 2007/358

(57) ABSTRACT

A K-band frequency modulated continuous wave (FMCW) weather radar system is provided for measuring precipitation in the atmosphere. The apparatus includes a RF transmitter which modulates the input signal of the first baseband unit, this transmitted baseband signal is scattered by the target. A RF receiver receives the signal and demodulates that signal. Further, this demodulated signal goes to mixer and is mixed with local oscillator to generate beat frequency. An IF (intermediate frequency) signal of K-band FMCW radar can be treated as time and frequency domain signals due to a unique property of linear frequency modulation (LFM). Frequency synthesizer generates a reference signal for coherent operation of overall FMCW radar system. The second baseband unit down-converts the beat signal and generates I/Q signal. Finally the signal is converted into digital form utilizing analog-to-digital converter.

### BACKGROUND

The present invention relates to an apparatus and method for measuring the precipitation in the atmosphere using a K-band frequency-modulated continuous wave (FMCW) weather radar system.

Much research has been carried out since the International Telecommunication Union (ITU) approved the frequency of 24-24.25 GHz for long range radar (LRR) systems. Numerous researches have been done regarding frequency modulated continuous wave (FMCW) radar operation in K-band for distance measurement in multiple target situations. Moreover, continuous-wave operation makes FMCW radars less complex, thus cheaper and more reliable than pulse radars.

These properties have caused the widespread use of FMCW radar technology for example in automotive applications. Similarly, in rain radar and industry K-band FMCW has many significant applications. The electromagnetic wave is transmitted from the weather radar in the atmosphere and influence by rain drops, hail, graupel, and snowflakes. In K-band, the attenuation due to rain effect may be noticeable, but it is weak enough to be correctable with sufficient accuracy.

Wireless communication systems require a channel sounder for the characterization of radio channel. In the past few decades, many researches have taken place on channel characterization by using different sounding techniques. The major purpose of channel sounding is to attribute a radio channel by decomposing the radio propagation path into its individual components.

There are different techniques for the channel sounding. For example, a radio channel can be characterized by using vector network analyzer (VNA) as a measurement device. This technique is not cost effective but very sensitive because its accuracy strongly depends on the physical layout between the two ports. The scattering parameter (S₂₁) is only reliable for very close measurement when operating on higher frequency, as the movement of the cable such as bending can change the impedance of the cable. In addition, due to time varying channels the measurement of channel frequency response can be changed, which leads to inaccurate impulse response measurement.

Another technique for channel sounding is pseudo random binary sequence radar which uses the spread spectrum technique. A merit of this technique is that it has a strong immunity to noise signals and adjustable sensitivity by the control of chip length. In the time domain, it employs a rectangular pulse which can be a sinc function in frequency domain. The sinc-like spectrum spreads in the frequency range that is not suitable for observing the specific frequency band.

An alternative but significant way is frequency-modulated continuous wave (FMCW) radar can be utilized for channel sounding. This radar continuously transmits electromagnetic waves with varying frequency. Its system stability, repeatability and reliable measurement conditions are the reason for utilizing this method.

### SUMMARY

The present invention is directed to measuring the precipitation in the atmosphere propagation using frequency modulated continuous wave (FMCW) weather radar system as a channel sounder.

In one general aspect of the present invention provides an apparatus for measuring precipitation in the atmosphere propagation in which FMCW radar is used as a channel sounder. The FMCW weather radar transmits a continuous radio wave frequency signal which is linearly swept. The transmitted signal hits the target and reflected back. Therefore, the received signal is the combination of these two signals. The frequency difference between the transmitted and received signals of FMCW radar indicates a delay ‘τ’ due to the propagation distance of radio frequency (RF) signal. This frequency difference is called an intermediate frequency (IF) signal and denoted as S_{IF}. The IF signal can be utilized as a time domain signal as well as frequency domain signal, a unique property of linear frequency modulation (LFM).

In the LFM technique, the IF signal of the FMCW radar is interpreted in terms of time domain. It has been investigated that the change of the sweep time corresponds to the change of the modulated frequency in the LFM. Therefore, the time-domain signal in the slow modulation is represented in the frequency domain signal without Fourier transform algorithm. Hence, the scattering parameter S₂₁ in the radio channel is proportional to the conjugate of the IF signal S_{IF} of the FMCW radar.

Consequently, the relationship between S₂₁ and S_{IF} can be expressed as follows,

$${S}_{21} ( {F}_{i} ) = k \cdot {[ {S}_{IF} ( {F}_{i} ) ]}^{*} , ( t = \frac{i}{N - 1} {T}_{m} )$$

where, k is an arbitrary constant, Fₜ the t-th frequency of IF signal, * the conjugate operation, i the number of intervals, N the number of sweep frequencies in the sweep period, and Tₘ the modulation time of the FMCW radar.

Similarly, the channel response can be extracted from the measured channel frequency response by performing an inversed discrete Fourier transform (IDFT) of S₂₁. According to above equation, the normalized impulse response (hₙₒᵣₘ) of the radio channel using FMCW radar is defined by the discrete Fourier transform (DFT) of S_{IF}, because the IDFT of the S₂₁ corresponds to the DFT of the S_{IF}. It can be written as,

$$\begin{matrix}{h}_{norm} ( τ , m ) = \frac{IDFT [ {S}_{21} ( {F}_{i} , m )}{max ( abs \{ IDFT [ {S}_{21} ( {F}_{i} , m ) ] \} )} \\ = \frac{DFT [ {{S}_{IF} ( {F}_{i} \cdot m )}^{*} ]}{max ( abs \{ DFT [ {{S}_{IF} ( {F}_{i} , m )}^{*} ] \} )}\end{matrix}$$

where, τ is the delay time and m the number of independent stirrer positions in the reverberation chamber.

Therefore, the normalized PDP can be defined by the impulse response as follows,

$$PDP ( τ ) = \frac{〈 {\vert {h}_{norm} ( τ , m ) \vert}^{2} 〉}{max [ 〈 {\vert {h}_{norm} ( τ , m ) \vert}^{2} 〉 ]}$$

where, < > is the expectation operator.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of frequency modulated continuous wave (FMCW) radar system according to one embodiment.

FIG. 2A is the RF transmitter inside blocks according to one embodiment.

FIG. 2B is the RF receiver inside blocks according to one embodiment.

FIG. 2C is the first baseband unit inside blocks according to one embodiment.

FIG. 2D is the second baseband unit inside blocks according to one embodiment.

### DETAILED DESCRIPTION

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

Although the terms first, second, etc. may be used to describe various elements, these elements are not limited by these terms. These terms are only used to distinguish one element from another. For example, a first element could be termed a second element, and, similarly, a second element could be termed a first element, without departing from the scope of exemplary embodiments. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, integers, steps, operations, elements, components and/or groups thereof.

Unless otherwise defined, all terms including technical and scientific terms used herein are to be interpreted as is customary in the art to which this invention belongs. It will be further understood that terms in common usage should also be interpreted as is customary in the relevant art and not in an idealized or overly formal sense unless expressly so defined herein.

With reference to the appended drawings, exemplary embodiments of the present invention will be described in detail below. Like numbers refer to like elements or elements corresponding to each other throughout the description of the figures, and the description of the same elements will not be reiterated.

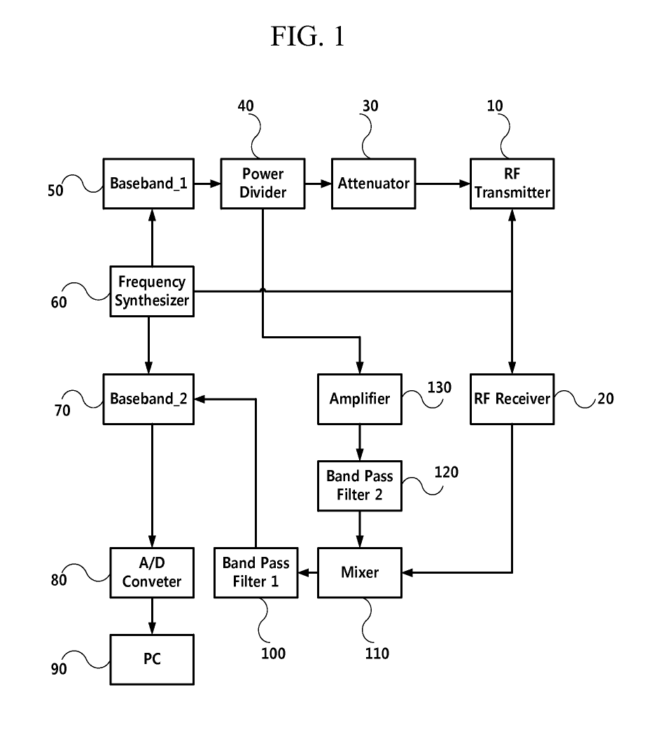

FIG. 1 is a system block diagram of frequency modulated continuous wave (FMCW) radar utilized as a channel sounder for measuring the precipitation in the atmosphere using K-band frequency-modulated continuous wave (FMCW) weather radar system according to an exemplary embodiment of the present invention.

Referring to FIG. 1, an apparatus for measuring the precipitation in the atmosphere using K-band frequency-modulated continuous wave (FMCW) to an exemplary embodiment includes a radio frequency (RF) transmitter 10, a radio frequency (RF) receiver 20, an attenuator 30, a power divider 40, a first baseband unit 50, a second baseband unit 70, a frequency synthesizer 60, an analog-to-digital (A/D) converter 80, a first band pass filter 100, a second band pass filter 120, a mixer 110, an amplifier 130, and a personal computer (PC) 90.

The RF transmitter 10 modulates the signal generated by first baseband unit 50 and transmits a radio wave. As a result, RF receiver 20 receives a radio wave and demodulates that signal. This demodulated signal goes to mixer 110 and is mixed with a local oscillator to create the beat frequency. The isolation between the RF transmitter and receiver antennas is −100 dB for example.

The attenuator 30 is used to adjust the power of the transmission signal. The power divider 40 divides the signal from first baseband unit 50 into transmission path and local oscillating path.

First baseband unit 50 generates the frequency-modulated continuous-wave signal. This generated signal goes to the RF transmitter 10 to be transmitted and is also used as local oscillator to create the beat frequency.

Frequency synthesizer 60 device that generates frequencies from a fixed oscillator. It generates a reference signal for coherent operation of the overall system. This generated signal is inputted to first baseband unit 50, second baseband unit 70, RF transmitter 10, and RF receiver 20.

Second baseband unit 70 down-converts the beat signal from the mixer and generates baseband quadrature (I/Q) signal. The obtained analog I/Q signal is then converted to a digital signal by analog-to-digital converter 80.

First band pass filter 100 suppresses harmonics generated by mixer 110 and only passes the beat frequency. While the mixer 110 mixes demodulated received signal with local oscillating signal from first baseband unit 50 to make beat frequency.

Second band pass filter 120 suppresses harmonics generated by amplifier 130 and only passes a power divided signal from first baseband unit 50. The amplifier 130 is used to amplify the signal from first baseband unit 50 to supply enough power of local oscillating signal into mixer 110. PC 90 receives the digital signal from A/D Converter 80 and processes that signal to get information.

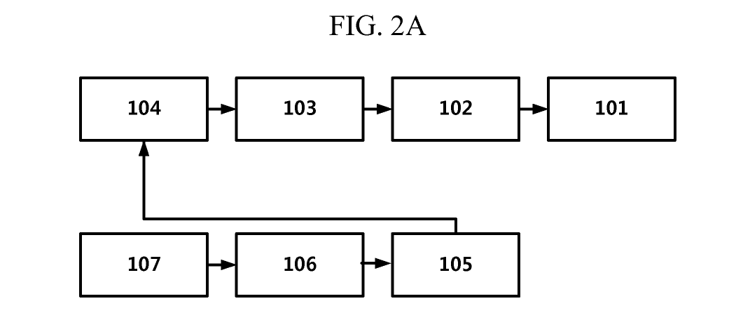

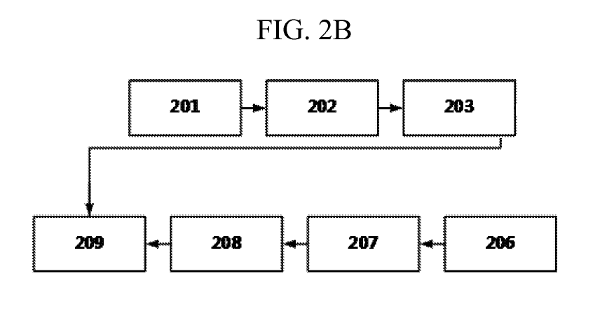

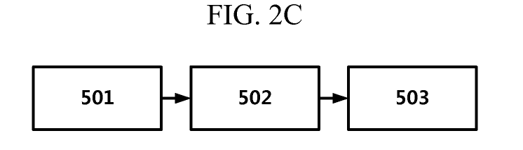

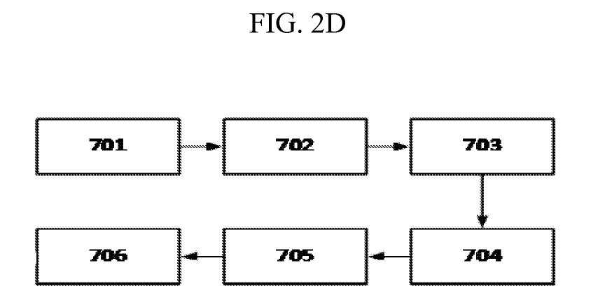

FIG. 2A shows the RF transmitter blocks included in the RF transmitter 10 according to one embodiment. The input signal is up-converted with transmitter phase locked loop (PLL) 107. This signal is passed through first band pass filter 106 and doubled by the frequency doubler 105. The signal then goes to mixer 104 and harmonics of up-converted are rejected by the first band pass filter 103. Before transmission, the signal is amplified with amplifiers 102 (e.g., three amplifiers) and then transmitted with the transmission antenna 101.

FIG. 2B shows the RF receiver blocks included in the RF receiver 20 according to one embodiment. The received signal is down-converted by the receiver phase lock loop (PLL) 201. Then the signal is filtered using second band pass filter 202 and amplified with an amplifier 203. The received signal from reception antenna 206 is firstly amplified with an amplifier 207 and passes through second band pass filter 208. Both band pass filter outputs are mixed using mixer 209.

FIG. 2C shows the first baseband unit blocks included in the first baseband unit 50 according to one embodiment. A direct digital synthesizer 501 signal is pass through a mixer 502 and filtered through a band pass filter 503 in one embodiment.

FIG. 2D shows the second baseband unit blocks included in the second baseband unit 70 according to one embodiment. The main purpose of this main block is to down-convert the IF band signal with baseband phase lock loop 701 to a baseband signal. After this the baseband signal gets amplified with an amplifier 702 and passes through a band pass filter 703. The signal is then inputted into a mixer 704 and then filtered 705 and amplified 706.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. An apparatus for measuring the precipitation in the atmosphere, comprising:
a radio frequency (RF) transmitter configured to modulate a signal and transmit a radio wave;
a RF receiver configured to receive the radio wave coming from a target and demodulate a signal;
a first baseband unit configured to generate a frequency-modulated continuous wave (FMCW) signal;
a second baseband unit configured to down-convert a signal and generate a quadrature (I/Q) signal;
an attenuator configured to adjust power of a transmission signal;
a power divider configured to divide a signal from the first baseband unit into a transmission path and a local oscillating path;
a frequency synthesizer configured to generate a reference signal for a coherent operation for an overall system;
a mixer configured to make beat frequency by mixing the demodulated received signal with a local oscillating signal from first baseband unit;
an amplifier configured to amplify a signal of the first baseband unit to supply enough power of the local oscillating signal into the mixer;
a first band pass filter configured to suppress harmonics generated by the mixer and pass the beat frequency; and
a second band pass filter configured to suppress harmonics generated by the amplifier and pass a divided signal from the first baseband unit.

2. The apparatus of claim 1, wherein the divided signal from the first baseband unit is amplified, filtered and up-converted.

3. The apparatus of claim 2, wherein in the RF transmitter at least one of the first band pass filter and the second band pass filter is used for selecting specific signals to transmit.

4. The apparatus of claim 2, wherein a phase lock loop (PLL) is utilized for up conversion and a frequency doubler has employed for doubling.

5. The apparatus of claim 1, wherein the received signal by the RF receiver is firstly channel-selected by at least one of the first band pass filter and the second band pass filter and then amplified, and the harmonics of the amplified signal are removed.

6. The apparatus of claim 4, wherein in the RF receiver the harmonics of the amplified signal are removed by being down-converted with the phase lock loop (PLL) and a frequency of the amplified signal doubles by the frequency doubler.

7. The apparatus of claim 6, wherein in the RF receiver one input signal is coming from the frequency synthesizer which is down-converted.

8. The apparatus of claim 5, wherein the down-converted signal by the RF receiver is filtered and passed through the mixer.

9. The apparatus of claim 1, wherein the first baseband unit comprises a direct digital synthesizer which is inputted to a reference source to make the frequency modulated continuous wave (FMCW) signal.

10. The apparatus of claim 9, wherein the reference source of the direct digital synthesizer is from the frequency synthesizer.

11. The apparatus of claim 1, wherein the second baseband unit down-converts an intermediate frequency (IF) band signal to a baseband.

12. The apparatus of claim 11, wherein the IF band signal of the second baseband unit is down-converted to the baseband with the phase lock loop signal and finally amplified with the amplifier and passes through the filter.

13. The apparatus of claim 12, wherein at least one of the first band pass filter and the second band pass filter is employed for filtering purpose.

14. The apparatus in claim 11, wherein in the second baseband unit after filtering and amplifying the I/Q signal is made by an I/Q mixer.
